(19) United States
(12) Patent Application Publication
(10) Pub. No.: US 2002/0046162 A1
(43) Pub. Date: Apr. 18, 2002

(54) Method and system for managing accounts receivable and payable and recording medium for storing program to realize the method

(75) Inventors: Masahiro Sakashita, Yokosuka (JP); Masayuki Nakagawa, Ichikawa (JP); Akira Ishibashi, Tokyo (JP); Shinya Hirata, Chigasaki (JP); Masashi Takeda, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 09/895,863

(22) Filed: Jun. 28, 2001

(30) Foreign Application Priority Data
Jun. 28, 2000 (JP) 2000-194955

(51) Int. Cl. G06F 17/60

(52) U.S. Cl. 705/39

(57) ABSTRACT

A virtual company acting as an intermediary for transactions manages accounts receivable and the accounts payable accrued between a seller organization and a buyer organization based on the ordering and order-receiving data, transfers funds and provides the financial services based on the accounts receivable. The virtual company relays the data from a party in transactions to the other party, prepares the accounts payable data and the payment management data for the buyer organization and sends them to the buyer organization, while preparing the inspected goods accounts receivable data and the receipts management data for the seller organization and sends them to the seller organization. The virtual company requests a bank to transfer funds, and notifies the seller organization that the financial services are available for the seller organization based on the accounts receivable accrued to the seller organization before the payment.

### CROSS-REFERENCES TO RELATED APPLICATIONS

This application claims priority from Japanese Patent Application No. 2000-194955, filed Jun. 28, 2000, which disclosure is incorporated herein by reference.

### BACKGROUND OF THE INVENTION

The present invention relates to a method and system for settling accounts, or in particular to a method and system for managing the accounts receivable and the accounts payable for commodities, materials, equipment, etc., sold or purchased, wherein data accrued about accounts receivable and accounts payable are managed based on order data, order-receipt data and delivery data of the sale, and funds for accounts receivable and accounts payable can be transferred while concurrently offering financial services to the parties holding the accounts receivable.

In recent years, transactions involving commodities, materials, equipment, etc. have frequently been conducted on a network. These transactions are expected to extend more widely in the future.

The accounts receivable and the accounts payable for inter-business transactions are established by the inspection by the buyer, and the accounts for the goods inspected by the buyer are settled at predetermined time intervals, for example, every month. The accounts for such transactions, even those conducted on a network, are settled by payment in a bank account or by postal transfer, both payment methods being executed separately from the ordering and order receipt procedures.

### BRIEF SUMMARY OF THE INVENTION

The present invention is based on findings that the turnover of funds is adversely affected by the limited opportunity for the seller to raise funds using accounts receivable, because accounts receivable are not established until the buyer inspects the delivered goods.

An object of the present invention is to provide a system and a method for transactions management, in which the accounts receivable and the accounts payable of the parties are calculated and managed based on the order data, order receipt data and delivery data exchanged between the parties, and financial services are provided based on the fund transfer procedure for settlement and/or the calculated data about the accounts receivable.

In one aspect the invention, a method of managing accounts receivable and accounts payable through an intermediary transaction is provided which comprises the steps of preparing and managing the data about the accounts receivable and accounts payable for each party in a transaction, based on the order data, the order-receipt data and the delivery data; sending the prepared data to each party; preparing and managing the payment management data and the receipt management data; sending the prepared data to each party; and instructing a financial institution to transfer funds based on the payment management data and the receipt management data.

Another aspect of the invention, provides a system for managing the accounts receivable and the accounts payable through an intermediary transaction comprising: a transaction intermediary unit connected to each of the processing means of each party in a transaction through a network for providing intermediary services, wherein the transaction intermediary unit includes means for relaying between the parties the order data, the order-receipt/delivery data and the inspection data from each party; means for preparing the accounts receivable data, the accounts payable data, the payment management data and the receipt management data, based on the order data, the order-receipt/delivery data and the inspection data; and means for sending the data thus prepared to each party.

### BRIEF DESCRIPTION OF THE DRAWINGS

FIG. 1 is a diagram for showing the configuration of an accounts receivable and accounts payable management system and data exchange according to a first embodiment of the invention.

FIG. 2 is a flowchart of the processing operation of the buyer.

FIG. 3 is a flowchart of the processing operation of the transaction intermediary unit.

FIG. 4 is a flowchart for explaining the processing operation of a company taking delivery.

FIG. 5 is a flowchart of the processing operation of a bank.

FIG. 6 is a diagram of the configuration of an accounts receivable and accounts payable management system and data exchange according to a second embodiment of the invention.

FIG. 7 is a diagram of the configuration of an accounts receivable and accounts payable management system and data exchange according to a third embodiment of the invention.

### DETAILED DESCRIPTION OF THE INVENTION

A method of managing accounts receivable and accounts payable and a system for managing those accounts in accordance with this invention is described in detail below with reference to the accompanying drawings.

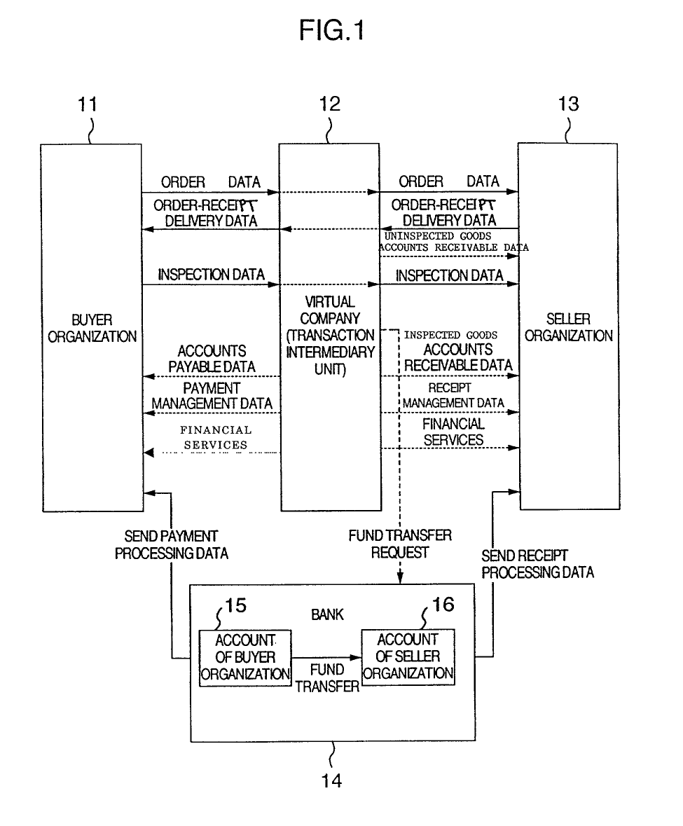

FIG. 1 is a diagram of the configuration of an accounts receivable and accounts payable management system and data exchange according to a first embodiment of the invention.

In FIG. 1, reference numeral 11 denotes a terminal held by a buyer; numeral 12 represents a transaction intermediary unit acting as an intermediary for transactions between the buyer and a seller; numeral 13 indicates a terminal held by a seller; numeral 14 denotes an account system processing unit for carrying out a procedure for settling accounts by transfer, or the like, through a financial institution such as a bank; numeral 15 represents a deposit account held by the buyer; and numeral 16 indicates a deposit account held by the seller.

In the transaction management system, as shown in FIG. 1, buyer terminal 1, seller terminal 13 and account system processing unit 14 are connected to transaction intermediary unit 12 through a network such as a telephone line network or the internet.

In the system according to this embodiment, the information from the seller and the buyer regarding transactions between them are transmitted and received through an intermediary, the amount of the seller's accounts receivable (the buyer's accounts payable) is managed, and the procedure for processing the request for fund transfer settlement is carried out.

In FIG. 1, the arrows between the units indicate transfer of data. Buyer terminal 11 of the buyer who is intending to purchase commodities, materials, equipment, etc. transmits the order data input to transaction intermediary unit 12. Transaction intermediary unit 12 transfers the received order data to seller terminal 13. The seller then delivers the ordered materials, equipment, etc. by a method not shown, inputs the order-receipt/delivery data indicating the specifics of delivery into seller terminal 13 and transmits these data to transaction intermediary unit 12.

Transaction intermediary unit 12 transfers the order-receipt/delivery data to buyer terminal 11, prepares the uninspected goods accounts receivable data based on the received order-receipt/delivery data, and transmits the data to seller terminal 13. After that, the buyer inspects the commodities delivered by the seller, inputs the inspection data indicating the inspection results and transmits them to transaction intermediary unit 12.

Transaction intermediary unit 12 transfers the received inspection data to seller terminal 13. In addition, transaction intermediary unit 12 prepares and sends to buyer terminal 11 the accounts payable data and the payment management data based on the received inspection data, and prepares and transmits to the seller terminal the inspected goods accounts receivable data and the receipts management data. Further, transaction intermediary unit 12 sends a fund transfer request to account system processing unit 14, while concurrently transmitting to seller terminal 13 and buyer terminal 11 information about financial services available for the seller in accordance with the accounts receivable held by the seller and for the buyer in accordance with the accounts payable held by the buyer, respectively.

Account system processing unit 14 receives the fund transfer request from transaction intermediary unit 12, and transfers the funds from deposit account 15 of the buyer to deposit account 16 of the seller. After processing the fund transfer, account system processing unit 14 transmits the payment processing data to buyer terminal 11, and transmits the receipt processing data to seller terminal 13.

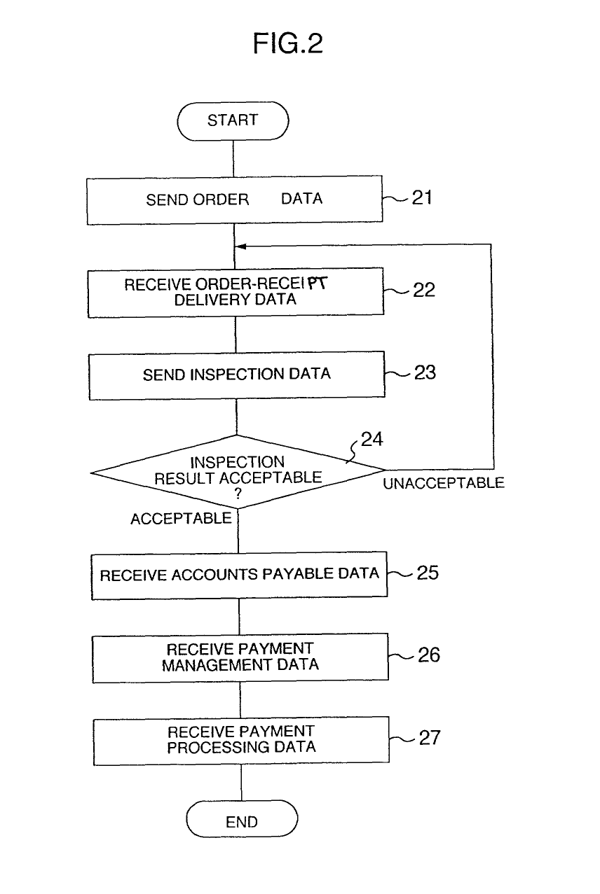

Each processing operation in buyer terminal 11, transaction intermediary unit 12, seller terminal 13 and account system processing unit 14 is now explained with reference to FIGS. 2-5.

FIG. 2 is a flowchart of the processing operation in buyer terminal 11. The order data indicating the specifics of an order from the buyer are input to buyer terminal 11, and the order data are transmitted from buyer terminal 11 to transaction intermediary unit 12 (step 21). The buyer receives through transaction intermediary unit 12 the order-receipt/delivery data input to seller terminal 13 (step 22). The seller is assumed to have carried out the delivery based on the order data by the time the order-receipt/delivery data is transmitted.

The buyer inspects the delivered commodities and inputs the inspection data indicating the results of inspection into buyer terminal 11, which sends the inspection data to transaction intermediary unit 12 (step 23). Transaction intermediary unit 12 checks to see whether the results of the inspection show that requirements have been met by the delivered materials, equipment, etc. If the requirements have not been met, transaction intermediary unit 12 records the unacceptability indicated in the transmitted inspection result as inspection data. Thus, the process returns to step 22 to wait for delivery of the materials, equipment, etc. and the receipt of the order-receipt/delivery data (step 24).

If the requirements have been met, buyer terminal 11 receives the accounts payable data, the payment management data and the payment processing data from transaction intermediary unit 12 (steps 25-27). Although not shown, after step 27, transaction intermediary unit 12 transmits to buyer terminal 11 the information on the financial services available for the buyer based on the amount of the accounts payable of the buyer indicated in the accounts payable data.

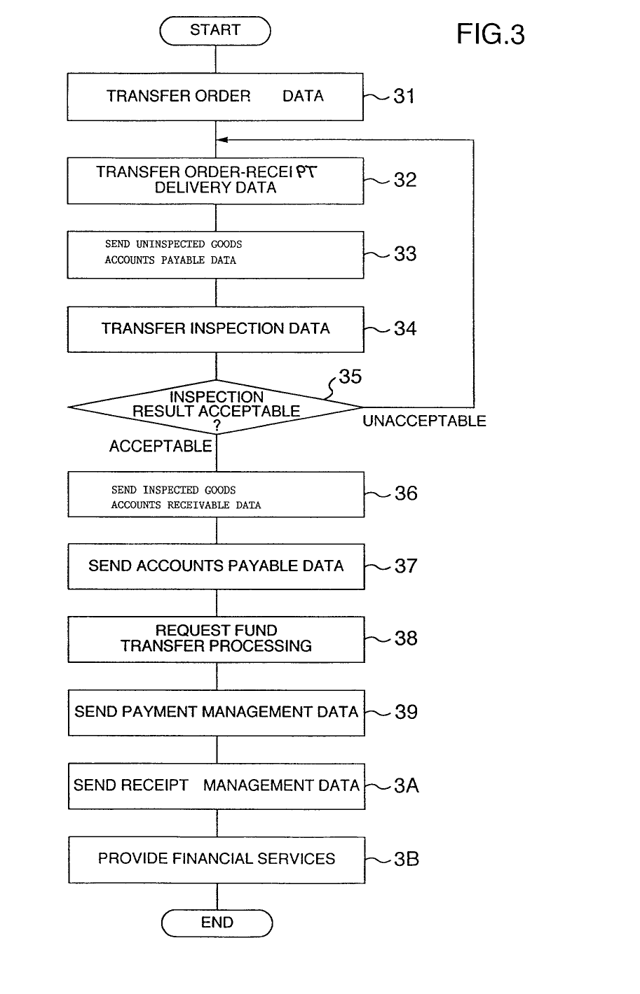

FIG. 3 is a flowchart of the processing operation in transaction intermediary unit 12. Transaction intermediary unit 12 receives the order data from buyer terminal 11, stores the order data, and transfers it to seller terminal 13. Transaction intermediary unit 12 receives the order-receipt/delivery data transmitted from seller terminal 13 in response to the order data, stores the order-receipt/delivery data, and transmits it to buyer terminal 11. Based on the order data and the order-receipt data, transaction intermediary unit 12 prepares the uninspected goods accounts receivable data and transmits it to seller terminal 13 (steps 31 to 33).

Transaction intermediary unit 12, which has received the inspection data transmitted by buyer terminal 11 in response to the order-receipt/delivery data, transfers it to seller terminal 13, checks to see whether the inspection data is acceptable, and when it is unacceptable, returns the process to step 32 of FIG. 2 to wait for receipt of the order-receipt/delivery data from seller terminal 13 for redelivery of materials, equipment, etc. required as the result of the initial delivery of unacceptable goods (steps 34, 35).

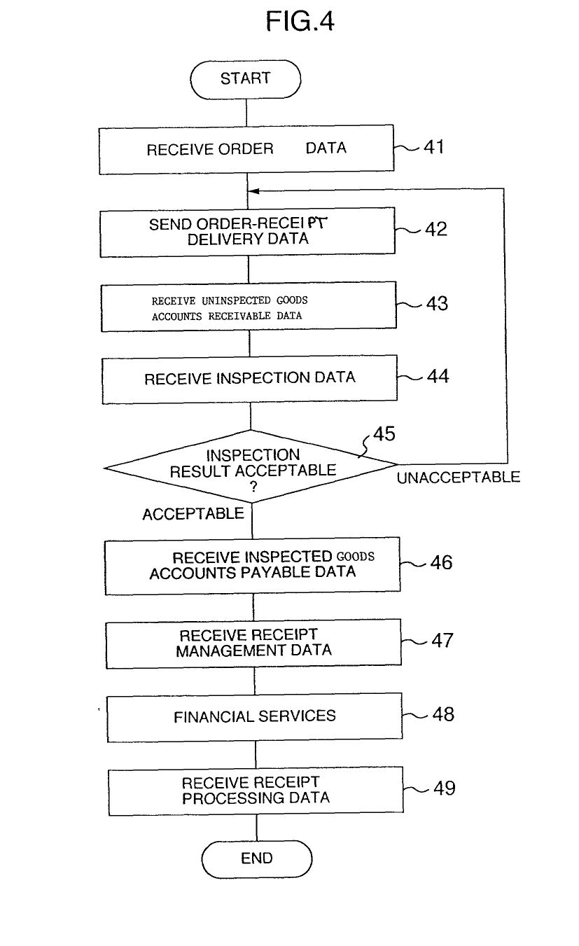

When the inspection result is acceptable at step 35, the inspected goods accounts receivable data and the accounts payable data are calculated based on the order-receipt/delivery data, and the inspected goods accounts receivable data is sent to seller terminal 13 while the accounts payable data is concurrently transmitted to buyer terminal 11 (step 36 of FIG. 3 and step 37 of FIG. 4).

Further, the amount of funds to be transferred, which is data required for settlement, is calculated from the inspected goods accounts receivable data and the accounts payable data. A find transfer request is transmitted to account system processing unit 14, and the payment management data and the receipt management data are prepared and transmitted to buyer terminal 11 and seller terminal 13, respectively (steps 38, 39, 3A).

Transaction intermediary unit 12 transmits to seller terminal 13 and buyer terminal 11 the information on the financial services available for the seller based on the amount of the accounts receivable of the seller indicated in the inspected goods accounts receivable data and for the buyer in accordance with the accounts payable held by the buyer, respectively (step 3B).

FIG. 4 is a flowchart for explaining the processing operation of seller terminal 13. The seller terminal 13 receives the order data input to buyer terminal 11 from transaction intermediary unit 12. The seller delivers the commodities based on the order data, and inputs the order-receipt/delivery data indicating the specifics of the delivered commodities to seller terminal 13. The seller terminal 13 transmits the order-receipt/delivery data to transaction intermediary unit 12 (steps 41, 42).

Seller terminal 13 receives, from the transaction intermediary unit 12, the uninspected goods accounts receivable data and the inspection data input to buyer terminal 11 (steps 43, 44).

The specifics of the inspection data are checked to determine whether the inspection result is acceptable or not. When the inspection is not acceptable, the process returns to step 42; the materials, equipment, etc. required due to the unacceptable inspection results are redelivered; and the corresponding order-receipt/delivery data is sent (step 45).

Seller terminal 13 receives the inspected goods accounts receivable data and the receipt management data from transaction intermediary unit 12 (steps 46, 47).

Seller terminal 13 also receives the information about the financial services available for the seller from transaction intermediary unit 12. In this case, the seller can receive financial services, if desired, by following the procedure of step 48, which is not shown in detail. Seller terminal 13 receives the receipt processing data prepared by account system processing unit 14 at the time of fund transfer (step 49).

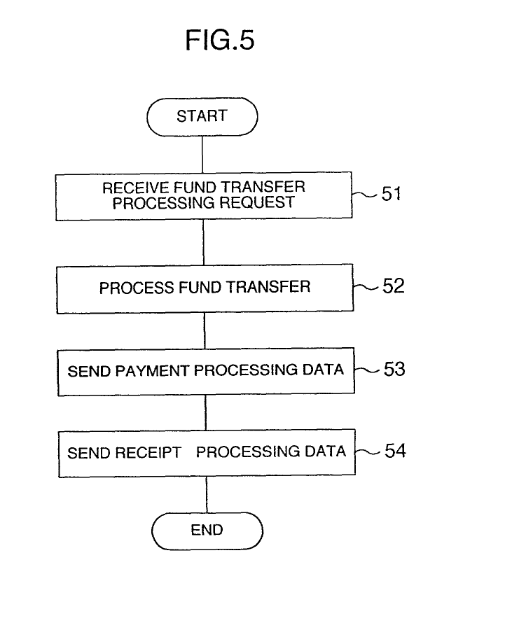

FIG. 5 is a flowchart of the processing operation of account system processing unit 14. Account system processing unit 14, upon receipt of a request for processing the fund transfer from transaction intermediary unit 12, transfers the funds from the buyer's deposit account 15 to the seller's deposit account 16 (steps 51, 52).

Account system processing unit 14 prepares the payment processing data and the receipt processing data for fund transfer processing, and sends the payment processing data to buyer terminal 11 while concurrently sending the receipt processing data to the seller 13, thereby completing the series of processing (steps 53, 54).

The first embodiment of the invention described above refers to circumstances in which transactions are conducted in one direction between two parties. Nevertheless, the invention is equally applicable to two-way transactions between two parties, one-way transactions among a plurality of parties, and two-way transactions among a plurality of parties as well. Examples of these transactions are now described.

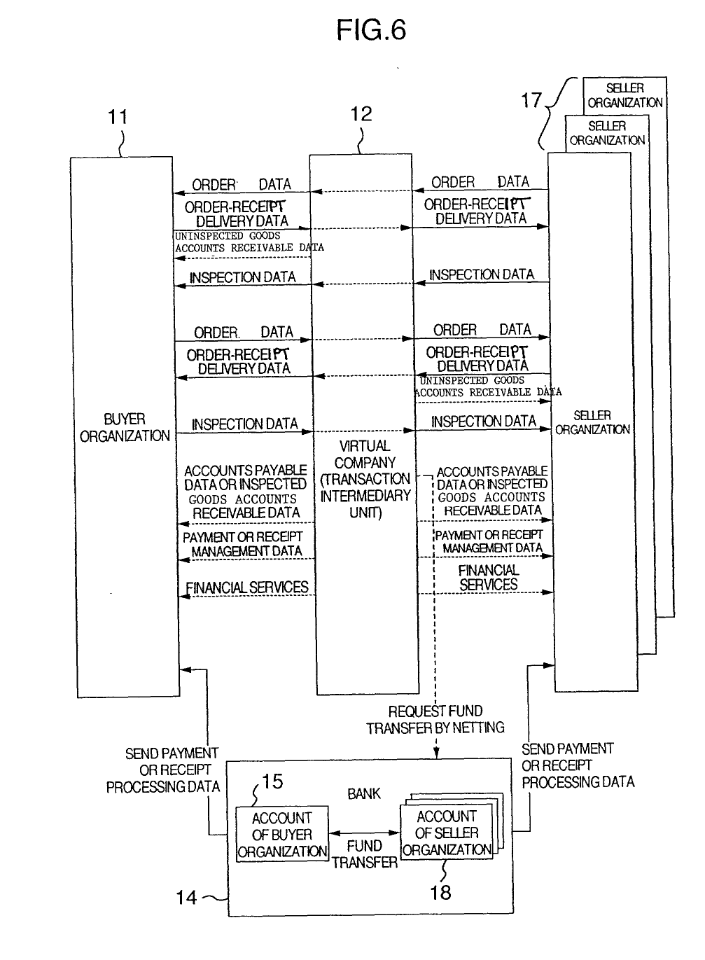

FIG. 6 is a diagram of the configuration of the transaction management system and the exchange of data according to a second embodiment of the invention. In FIG. 6, numeral 17 denotes seller terminals, and numeral 18 indicates the deposit accounts of the sellers. The other reference numerals denote the same component parts as those in FIG. 1. The second embodiment of the invention, as shown in FIG. 6, represents circumstances in which two-way transactions are conducted between two organizations. The system configuration can be the same as that of FIG. 1. In this case, seller 13 of FIG. 1 corresponds to the sellers 17, and the sellers and the buyer conduct two-way transactions. FIG. 6 shows a plurality of sellers, and transactions between each of them and a buyer are conducted similarly.

In FIG. 6, the processing operation including the step of sending the order data for the two-way transactions to the step of receiving the inspection data are performed in the same manner as the operation explained in FIGS. 1 to 4, except that the transactions are conducted on a two-way basis. Transaction intermediary unit 12, upon completing the aforementioned process, checks the inspection data from the two parties, and upon confirming that the inspection result is acceptable, performs a netting process for offsetting the accounts receivable and accounts payable between the two parties. As the result of this netting, the accounts receivable are accrued for one party, either the buyer or the seller, and the accounts payable are accrued for the other. Transaction intermediary unit 12 sends these data and the corresponding payment management data and receipt management data to the buyer and the seller, while concurrently requesting bank 14 to perform the process for fund transfer. Transaction intermediary unit 12 notifies the buyer or the seller, whichever the accounts receivable are accrued for, that financial services can be received before the payment.

Bank 14, upon receipt of the fund transfer request described above, carries out the process between buyer account 15 and seller account 18, so that the payment processing data is sent to one party, either the buyer or the seller, and the receipt processing data is sent to the other.

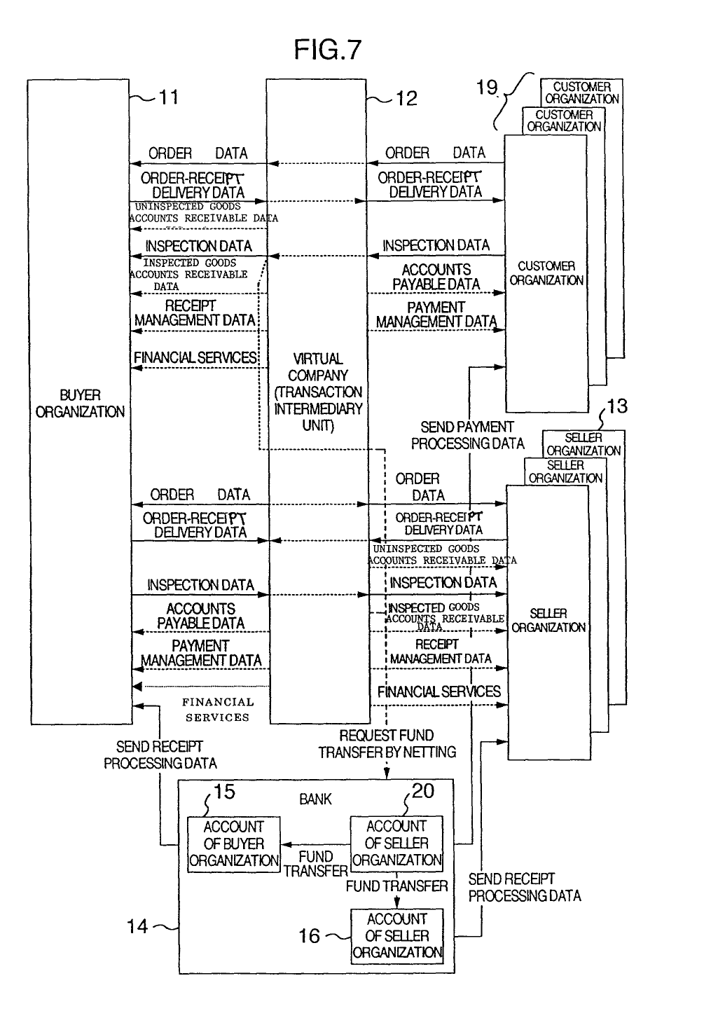

FIG. 7 is a diagram of the configuration of the transaction management system and the data exchange according to a third embodiment of the invention. In FIG. 7, numeral 19 denotes customer terminals (buyer organization 11 has customers 19 here), and numeral 20 indicates deposit account of the buyer. The remaining reference numerals denote the same component parts as the corresponding ones in FIG. 1. The third embodiment of the invention as shown in FIG. 7, represents circumstances in which transactions are conducted in on a one-way basis among a plurality of organizations. This embodiment is configured the same way as the two-party, one-way transaction shown in FIG. 1, except that customer organizations 19 are added to the network. In the transactions according to this embodiment, the buyer receives an order for a product from one or more customer organizations 19, manufactures the product by purchasing materials and equipment from the seller, and delivers the product to the customer organizations. The transactions between the buyer as one party and a plurality of customer organizations and a plurality of sellers as another party, as shown in FIG. 7 are conducted in similar fashion.

In FIG. 7, the process of transactions ranging from the step of customer organizations 19 sending the order data to the step of the buyer and customer organizations' receiving the receipt management data and payment management data, is conducted in a manner similar to the process of transactions for these steps as described in FIGS. 1-4. In addition, exactly the same process as in the aforementioned embodiment of FIGS. 1-4 is performed in this embodiment between the buyer and the seller. In this embodiment, the accounts receivable charged against the customer organizations 19 are accrued to the buyer and the accounts receivable charged against the buyer are accrued to the seller during the whole transaction. Transaction intermediary unit 12 thus notifies both the buyer and the seller that the financial services are available to them.

At an appropriate point, when the receipt management data and the payment management data are prepared for the three parties during the transaction process described above, transaction intermediary unit 12 requests bank 14 to transfer funds. Upon receipt of this request, bank 14 carries out the fund transfer among the accounts 15, 20 and 16 held by the buyer, the customer organizations 19 and the seller, respectively. In the case shown in FIG. 7, the funds are transferred from the account of the customer organization 20 into the account 15 of the buyer and the account 16 of the seller.

The first to third embodiments described above refer to a one-way transaction between two parties, a two-way transaction between two parties and a one-way transaction among a plurality of parties. The present invention, however, is not confined to the examples described in these embodiments, but is equally applicable to, for example, two-way transactions among a plurality of parties. In such circumstances, the netting of the accounts receivable and the accounts payable between the parties is carried out in transaction intermediary unit 12, and a financial institution or the like is requested to settle only the difference. As a result, the settlement fee payable to the financial institution or the like by the parties taking part in the system is reduced as a whole.

According to the embodiments of the invention described above, transaction intermediary unit 12 can summarize the order and order-receipt data and can prepare settlement data based on the order and order-receipt data thus summarized. Therefore, financial and other services can be provided based on the management of the accounts receivable and accounts payable, settlement of the difference and subsequent reconciliation of the accounts receivable.

Moreover, the organizations ordering or receiving an order through transaction intermediary unit 12 not only can enjoy the offered financial services but also can outsource jobs such as accounts receivable management, accounts payable management and cash transfer management.

It will thus be understood from the foregoing description that according to this invention, a transaction intermediary unit acting as an intermediary for the sale and purchase of commodities, materials and equipment can manage the data of the accounts receivable and the accounts payable accrued to the parties engaged in the transaction based on the order data, the order-receipt data and the delivery data, can transfer the funds required for the accounts receivable and the accounts payable, and can offer financial services to the parties holding the accounts receivable. Further, according to this invention, the organizations ordering or receiving an order through the transaction intermediary unit not only can enjoy offered financial services but also can outsource the management of the accounts receivable, the accounts payable, and the cash flow management functions.

What is claimed is:

1. A method of managing the accounts receivable and the accounts payable through an intermediary of transactions, comprising the steps of:
preparing and managing the data on the accounts receivable and the accounts payable for each of the parties in transactions based on the ordering data, the order-receiving data and the delivery data between said parties;
sending the prepared data on the accounts receivable and the accounts payable to each party;
preparing and managing the payment management data and the receipts management data; and
sending the payment management data and the receipts management data thus prepared to each party.

2. A method of managing the accounts receivable and the accounts payable according to claim 1, further comprising the step of instructing a financial institution to transfer funds based on said payment management data and said receipts management data.

3. A method of managing the accounts receivable and the accounts payable according to claim 1, further comprising the step of providing the financial services based on said accounts receivable data.

4. A method of managing the accounts receivable and the accounts payable according to claim 2, further comprising the step of providing the financial services based on said accounts receivable data.

5. A system for managing the accounts receivable and the accounts payable through an intermediary of transactions, comprising a transaction intermediary unit connected to the processing means of each party in transactions through a network for acting as an intermediary for transactions,
wherein said transaction intermediary unit includes means for relaying, between the parties, the ordering data, the order-receiving/delivery data and the inspection data from the parties concerning the transactions, means for preparing the accounts receivable data, the accounts payable data, the payment management data and the receipts management data based on the ordering data, the order-receiving/delivery data and the inspection data, and means for sending the data thus prepared to the parties.

6. A system for managing the accounts receivable and the accounts payable according to claim 5, further comprising processing means of a financial institution connected through a network,
wherein said transaction intermediary unit further includes means for instructing the financial institution to transfer funds based on said payment management data and said receipts management data, and
wherein said financial institution includes means for transferring funds between the parties in response to said fund transfer request and means for sending each of the parties the payment processing data and the receipts processing data constituting the result of said fund transfer processing.

7. A recording medium for realizing the method of managing the accounts receivable and the accounts payable according to claim 1, said recording medium being adapted to store therein:
a processing program for receiving the ordering data, the order-receiving data and the delivery data between the parties in transactions;
a processing program for preparing and managing the accounts receivable data and the accounts payable data for each party based on said ordering data, said order-receiving data and said delivery data;
a processing program for preparing and managing the payment management data and the receipts management data; and
a processing program for sending said data prepared to each of said parties.
